(19) United States
(12) Patent Application Publication
(10) Pub. No.: US 2023/0016195 A1
(43) Pub. Date: Jan. 19, 2023

(54) METHOD FOR OPERATING A RADAR SYSTEM

(71) Applicant: HELLA GmbH & Co. KGaA, Lippstadt (DE)

(72) Inventors: Frank GRUENHAUPT, Marsberg (DE); Juergen KOEHLER, Moehnesee (DE); Matthis WIELAGE, Erwitte (DE)

(73) Assignee: HELLA GmbH & Co. KGaA, Lippstadt (DE)

(21) Appl. No.: 17/947,832

(22) Filed: Sep. 19, 2022

Related U.S. Application Data
(63) Continuation of application No. PCT/EP2021/055171, filed on Mar. 2, 2021.

(30) Foreign Application Priority Data
Mar. 18, 2020 (DE) 10 2020 107 372.0

(51) Int. Cl. G01S 7/40; G01S 13/931

(52) U.S. Cl. CPC G01S 7/40; G01S 13/931; G01S 2013/93275

(57) ABSTRACT

A method for operating a radar system, which includes at least two radar sensors. A signal is transmitted in the radar sensors for transmitting at least one radar signal. A signal processing is performed in the radar sensors for ascertaining a piece of detection information by the radar sensors in each case, which is specific to the radar signal transmitted. A disturbance evaluation is performed for detecting at least one disturbance in the radar sensors based on the particular piece of detection information. At least one adjustment option is provided for avoiding the at least one detected disturbance by an adjustment of the signal transmission. An evaluation is performed of the at least one adjustment option for the radar sensors and a coordination of the adjustment options is performed. An adjustment of the signal transmission is performed according to the at least one adjustment option.

This nonprovisional application is a continuation of International Application No. PCT/EP2021/055171, which was filed on Mar. 2, 2021, and which claims priority to German Patent Application No. 10 2020 107 372.0, which was filed in Germany on Mar. 18, 2020, and which are both herein incorporated by reference.

### BACKGROUND OF THE INVENTION

### Field of the Invention

The present invention relates to a method for operating a radar system.

### Description of the Background Art

It is known from the prior art that radar systems are used, among other things, in vehicles to monitor surroundings of the vehicle. Radar systems of this type may include at least one radar sensor operated in a network. The radar sensors make it possible to detect target object in the surroundings. A comprehensive signal processing may be carried out to ascertain parameters of the detected target objects, for example a distance, a relative speed, or a direction of the target object with respect to the vehicle. However, the computing power of the hardware used for signal processing is often limited, so that the computing complexity of the signal processing must be reduced. Moreover, mutual disturbances of the radar sensors of different vehicles may frequently occur, due to the increasing use of radar systems in road traffic. These disturbances, such as inferences, may significantly impair the functionality of the radar systems.

The increasing spread of radar systems therefore also goes hand in hand with the disadvantage that different radar systems may negatively influence each other. Disturbances of this type due to radar systems influencing each other are also referred to as interferences.

There is frequently also the problem that the interferences may not be reliably detected or eliminated in a radar system.

A radar system is known from the publication DE 10 2013 210 256 A1, which corresponds to US 2016/0124075, in which two FMCW radar sensors are used in a network.

### SUMMARY OF THE INVENTION

It is therefore an object of the present invention to at least partially eliminate the disadvantages described above. In particular, the object of the present invention is to propose an improved approach for detecting and reducing disturbances, such as interferences.

In an exemplary embodiment, the object is achieved, in particular, by a method for operating a radar system, which includes at least two radar sensors. It is provided, in particular, that the following steps are carried out, preferably consecutively in the specified or in an arbitrary order, it also being possible to repeatedly carry out individual and/or all steps: carrying out a signal transmission in the radar sensors to transmit at least one radar signal in each case (by the radar sensors), preferably by at least one transmitting antenna of the particular radar sensor, in particular in the form of an electromagnetic signal, transmitted into surroundings outside the radar sensor; carrying out a signal processing in the radar sensors to ascertain a piece of detection information by the radar sensors in each case, which is specific to the radar signal transmitted in each case, in particular to the transmitted radar signal reflected on a target object and delayed by a signal propagation time, which may be received, for example, by at least one receiving antenna of the radar sensor; carrying out a disturbance evaluation to detect at least one disturbance in the radar sensors in each case, based on the particular detection information, the disturbance evaluation preferably being able to be carried out centrally in the particular radar sensors for all of the pieces of detection information or individually for the particular pieces of detection information; providing at least one or at least two or at least four or at least six adjustment option(s) for avoiding the at least one detected disturbance by an adjustment of the signal transmission; carrying out an evaluation of the at least one adjustment option for each of the radar sensors, in particular, by each of the radar sensors; carrying out a coordination of the adjustment options between the different radar sensors, based on the evaluation; and/or carrying out the adjustment of the signal transmission according to the at least one adjustment option depending on the coordination, in particular, only if the adjustment option effectuates a reduction of the disturbance for the overwhelming majority of the radar sensors and/or by a selection of the adjustment option which effectuates the reduction of the disturbance for the overwhelming majority of the radar sensors.

This has the advantage that, for the adjustment, not only the effect of the disturbance on one radar sensor is taken into account, but also the effect on the other radar sensors.

In the case of the signal transmission, the radar signal may be transmitted for each radar sensor—as a transmit signal s(t)—by at least one transmitting antenna of the radar sensor. Each transmit signal s(t) may comprise multiple frequency-modulated ramps (chirps), which are also referred to below as component signals. The transmit signal s(t) reflected on a target object and delayed by a signal propagation time r may then be received as a receive signal e(t) at at least one receiving antenna of the radar sensor. During and/or even prior to the signal processing, it may then be provided that, for each radar sensor, the baseband signal b(t) is obtained from the mix of the transmit signal s(t) and the receive signal e(t), the frequency f_{b}=fₛ−fₑ. f_{b} being dependent on the signal propagation time τ and thus on the distance R of the target object. The disturbance occurs in the form of an interference if two radar systems transmit at the same point in time in the same frequency range (in spatial proximity to each other).

The disturbance may primarily relate to an interference by an external radar system. To avoid internal interferences of the radar sensors of the radar system among each other, further measures may also be provided. For example, if the radar signals of different radar sensors transmit temporally offset from each other or in different frequency ranges. In this connection, one may speak of an offset arrangement of radar signals in the frequency-time space. The temporal arrangement may take place in multiple predefined time windows (acquisition slots). The disturbance in the form of an external interference may be arranged in this frequency-time space. The arrangement of the disturbance may be ascertained, for example, by the disturbance evaluation. To avoid the disturbance, the arrangement of the radar signals in the frequency-time space may be adjusted to then evade the disturbance. In other words, due to the adjustment option(s), the disturbances may be evaded in a targeted manner in the frequency-time space by a delayed transmission and/or a change of the center frequency of the radar signals. Each adjustment option may represent a different parameterization of the delay and/or the center frequency, which is suitable for evading the disturbance. To nevertheless continue to prevent the internal interferences, the radar signals must be adapted in a synchronized manner. An adjustment of the arrangement in the frequency-time space for the radar signal of one of the radar sensors then results in an adjustment in the same way of the arrangement for the radar signal of the other radar sensors. It is then no longer possible to evade only one individual synchronized radar sensor without disturbance, since a superimposition with the chirp signal in the adjacent acquisition slot may occur, i.e., in the time windows for the radar signals. As a result, the radar sensors may no longer autonomously decide on their best evasion strategy in the frequency-time space. All radar sensors must apply, for example, the same time delay of the transmit signal to be able to continue operating synchronously without overlapping. The best evasion strategy must be coordinated, in particular, with all radar sensors in the network, since a time delay of the transmit signal may have a different effect for each radar sensor, depending on the disturbance scenario.

Each radar system may have a different field of vision and thus be influenced by different disturbances. To evaluate the at least one and, in particular, multiple adjustment option(s), in the form of an adjustment strategy in each case, during the evaluation by the individual radar sensors, the following steps may be provided. For example, a maximum delay period may be defined as tx_{delayMax} and be divided into Nₜₓ delay steps. Each of these delay steps then corresponds to one adjustment option. Each radar sensor of the radar system may evaluate the effects of one of each of the Nₜₓ possible delay steps, based on a position of the at least one detected disturbance in the frequency-time space predicted by the disturbance evaluation and store the Nₜₓ evaluation results.

The Nₜₓ evaluation results may then be transferred to all other radar sensors of the radar system during the coordination. The evaluation results of all other radar sensors are then present in each radar sensor. The signal transmission may then be adjusted in such a way that the ideal delay step is selected as the adjustment option, which results in the best result for all radar sensors.

It may furthermore be advantageous if an interference value is determined for each adjustment option during the evaluation, i.e., for example, for each potential position of a chirp sequence in the frequency-time space or for each potential time window, depending on the detected disturbance. This interference value may be determined, for example, as an extent of the influence of the disturbance on the radar signal during the adjustment according to the adjustment option. The interference value thus represents a measure of the effect of the adjustment option for the particular radar sensor. An interference value for a radar sensor is, for example, proportional to the overlapping of the disturbance and the radar signal of this radar sensor, if the radar signal is assumed to be at the potential position according to the adjustment option. The interference value is thus present for each adjustment option for each radar sensor. The interference values for the different radar sensors may then be added up for each adjustment option, it being possible for the interference values of different radar sensors to have different weights, if necessary. If necessary, a radar sensor which is in a critical scenario from the perspective of functional safety (FUSA) may have a higher weighting. By a comparison of the added-up interference values, the ideal adjustment option, e.g., the ideal time window, may then be determined, which leads to the best result for all radar sensors. For example, a minimum search for a summation is conceivable here. Other approaches to selecting the adjustment option may also be selected, for example a combination with a criterion that no radar sensor is permitted to have the highest interference value.

It may be provided that the transmission of the radar signals and/or the signal processing and/or the disturbance evaluation and/or the evaluation by each of the radar sensors is carried out autonomously, i.e., Independently of the other radar sensors. In each case, the signal processing and/or the disturbance evaluation and/or the evaluation is carried out by the radar sensors only based on the particular detection information of this radar sensor. During these steps, therefore, one radar sensor does not yet take into account the detection information of the other radar sensors. Only in the coordination step may a radar sensor take into account the results of these steps of the other radar sensors. For example, a first piece of detection information is ascertained by the first radar sensor, so that the signal processing and/or the disturbance evaluation and/or the evaluation may be carried out for the first radar sensor only based on the first piece of detection information. For example, a second piece of detection information is ascertained by the second radar sensor, so that the signal processing and/or the disturbance evaluation and/or the evaluation may be carried out for the second radar sensor only based on the second piece of detection information. Only during the coordination is the result of the evaluation of the first radar sensor as well as that of the second radar sensor taken into account.

It may furthermore be possible that the radar sensors are operated in a synchronized manner to transmit the at least one radar signal in a synchronized manner in each case during the signal transmission, so that the radar signals of the different radar sensors are transmitted, temporally offset and/or frequency-offset (i.e., offset with regard to a center frequency).with respect to each other. In a further possibility, it may be provided that the radar signals of the different radar sensors are transmitted partially temporally in parallel and offset in a frequency-time space in such a way that component signals of the radar signals, in particular frequency-modulated ramps, are transmitted without overlapping with regard to the frequency. Specifically, the method according to the invention may be used to avoid interference between synchronized radar sensors (in particular of a vehicle) and external radar sensors. The synchronized radar sensors thus form a sensor network to avoid disturbances of the radar sensors among each other. This is particularly useful if multiple radar sensors are used to monitor surroundings, for example, on different sides of a vehicle.

The radar signal comprises, for example, multiple sequentially transmitted signal sequences (also referred to a chirps or frequency modulation ramps). The chirps may each be frequency-modulated and thus have a varying frequency. For example, a linear frequency modulation may be used, in which the frequency of a particular chirp is varied linearly within a predefined bandwidth. An interference may occur if two radar systems (in spatial proximity to each other), in particular of different vehicles, transmit at the same point in time in the same frequency range. The interference signal may occur in the time range in the form of a peak value (peak) in baseband signal b(t) and thus result in an increasing of a spectrum A(f) of baseband signal b(t) in the frequency range.

To carry out the detection of the at least one target object, the detection information may be ascertained in the particular radar sensors, based on receive signal e(t) and, in particular, based on baseband signal b(t). For example, the detection information results from digitized baseband signal b(t) or from a frequency analysis of baseband signal b(t). Correspondingly, the piece of detection information may be a piece of digital information, i.e., data values. If a sequence of N chirps is output in a radar signal, the time period of a particular chirp is then T1/N. After time period T1, the processing of the detection information may take place within time period T2-T1. The entire measurement cycle thus has a time period T2, so that the transmission of radar signal s(t) may be repeated at intervals of T2. T2 thus defines a radar signal spacing. Different transmit signals s1(t) and s2(t) may be transmitted by the different radar sensors, which differ from each other. for example, with regard to a starting time for T1.

It is furthermore conceivable that the adjustment of the signal transmission carries out at least one of the following adjustments: according to at least one first of the at least one adjustment options, an adjustment of a frequency range, in which the radar signals are transmitted, in particular, by a changing of a center frequency of the radar signals; and/or according to at least one second of the at least one adjustment options, an adjustment of a time delay, by which the radar signals are transmitted, in particular, by an adjustment of a starting time of the radar signals, e.g. For T1;

Multiple first and/or second adjustment options may also be provided, which each define different parameters for the time delay (such as different starting times and/or time windows) and/or center frequencies. The evaluation is used to establish the effect of these parameters on the particular individual radar sensors, i.e., the individual effect on the radar sensors. During the coordination, the overall effect on all radar sensors may then be examined. Since a freely variable establishment of the center frequency and/or the delay is not useful in a network of radar sensors, the coordination of the radar sensors is thus carried out to improve the overall effect of the adjustment.

Within the scope of the invention, it may also be advantageous that the adjustment of the signal transmission is carried out identically for all radar sensors. Alternatively, or additionally, it may be provided within the scope of the invention that, by adjusting the signal transmission, an adjustment of a time delay, by which the radar signals are transmitted to avoid disturbances, is carried out to the same extent for all radar sensors. It may furthermore be alternatively or additionally provided for this purpose that, by adjusting the signal transmission, the frequency range in which the radar signals are transmitted is changed to the same extent for all radar sensors. The sensors may thus no longer autonomously decide on their best evasion strategy in the frequency-time space. All sensors must then apply the same time delay of the radar signal to be able to continue operating synchronously without overlapping.

It is furthermore conceivable that a result of the disturbance evaluation is used to predict a disturbance of the pieces of detection information. The advantage may be achieved that, by evaluating the disturbance—f or example by using a neural network and/or by taking into account preceding disturbance revaluations—a reliable and possibly faster detection of the disturbance is made possible, This may be due to the fact that not (only) is a currently present disturbance detected, but the prediction of the disturbance is even made possible by the disturbance evaluation. The disturbance evaluation may be carried out for this purpose in such a way that a recurring profile and/or a recurring pattern and/or a temporal correlation of the disturbance in the pieces of detection information may be recognized, based on the preceding disturbance evaluations. The neural network may be able to do this if a temporal link of neurons takes place in the sense of feedback loops (like in a recurrent neural network). In this way, pieces of time-coded information in the pieces of detection information may be ascertained, which are specific to the disturbance and therefore facilitate a prediction of the disturbance. In addition to the current detection information, pieces of detection information of temporally preceding detection cycles of the radar system may also possibly be taken into account in the disturbance evaluation.

Within the scope of the invention, it is further conceivable that at least one disturbance is detected in each case in the radar sensors, based on the particular detection information, in such a way that the disturbance evaluation comprises an application of a neural network in each case for the purpose of providing a prediction of the disturbance in such a way that an indication of a disturbance frequency range, in which the disturbance will be present in the future, takes place due to the neural network. This makes use of the fact that the disturbance—in particular, in the form of an interference—impairs only a limited frequency range. The disturbance may thus be reliably characterized based on the frequency range. To train the neural network for this functionality, previously ascertained pieces of detection information may be used as training data, in which the frequency range for a disturbance is manually marked. The pieces of detection information may then be used as training data for the training in such a way that the pieces of detection information, which preceded the pieces of detection information having the manually marked frequency range (i.e., the ground truth), are used as input for the purpose of predicting the future presence of the disturbance in this way.

Within the scope of the invention, it may be preferably provided that the disturbance evaluation takes place based on the pieces of detection information of a current detection cycle of the radar systems for the purpose of obtaining an indication of a disturbance frequency range as a result of the disturbance evaluation, in which the disturbance is predicted in a detection cycle temporally subsequent to the current detection cycle, the adjustment of the signal transmission preferably comprising an automatic, at least partial adjustment of the frequency range of the radar signals, so that the radar signals are transmitted in a frequency range which is at least partially outside the predicted disturbance frequency range. In this way, the radar signals may be transmitted in the frequency range which is at least partially outside the predicted disturbance frequency range. The at least one frequency range may then be carried out as an at least partially variable frequency range. This makes it possible to reliably reduce the disturbance, since the disturbance frequency range is circumvented.

Moreover, it may be provided that the disturbance evaluation is carried out separately and, in particular, autonomously in each case for the pieces of detection information from different radar sensors, and a result of the evaluation of each of the radar sensors is used for the coordination. The overall effect on the total radar system may thus be taken into account in the adjustment.

According to a further possibility, it may be provided that the carrying out of the evaluation of the at least one adjustment option for each of the radar sensors comprises the following step: evaluating an effect of each adjustment option in the form of a disturbance effect on the radar sensor, based on at least one current and/or predicted disturbance detected by the disturbance evaluation.

The result of the evaluation may be transferred to the other radar sensors (e.g., during the coordination).

It may be advantageously provided according to the invention that the radar system is part of a vehicle. The vehicle is, for example, a passenger car and/or a truck, which may provide at least one vehicle function, such as a driver assistance system, with the aid of the radar system.

It is also optionally conceivable that the radar sensors each include a processing device for carrying out at least the evaluation and/or that the radar system is designed to detect at least one target object in surroundings of the radar system, in particular of a vehicle, the radar system including the at least two radar sensors for different surroundings regions of the surroundings. It is alternatively or additionally conceivable that the radar system includes at least four radar sensors or at least six radar sensors.

In addition, it is optionally possible that the at least one neural network comprises at least one convolutional neural network (CNN), which preferably receives the detection information as input and whose output is used as input for the recurrent neural network. This makes it possible, for example, to reduce the volume of data of the detection information for processing by the recurrent neural network (RNN) and/or to pre-evaluate it for extracting a piece of information about the disturbance. The performance of the processing may thus be improved by the RNN. For this purpose, the CNN is trained, for example using training data, which are made up of input data (input) and the corresponding output data (output). Within the scope of a “monitored learning,” the output data may contain the correct output, which is expected in the case of the corresponding input data. The input data are, for example, the unchanged pieces of detection information, and the output data are a size-reduced (scaled) version of the pieces of detection information or a marking of the disturbance. In this way, the CNN is trained to supply an optimized input for the RNN as the output.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of a vehicle, including a radar system, in a side view;

FIG. 2 shows a schematic representation of a vehicle, including a radar system, in a top view;

FIG. 3 shows a schematic representation of a signal transmission;

FIG. 4 shows a schematic representation of a disturbance during a signal transmission;

FIG. 5 shows a schematic representation of an adjustment of the signal transmission according to one adjustment option;

FIG. 6 shows a schematic representation of an adjustment of the signal transmission according to a further adjustment option;

FIG. 7 shows a schematic representation of an adjustment of the signal transmission according to a further adjustment option; and

FIG. 8 shows a schematic visualization of method steps.

### DETAILED DESCRIPTION

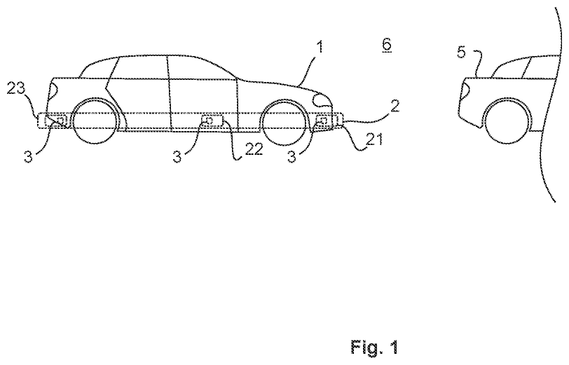

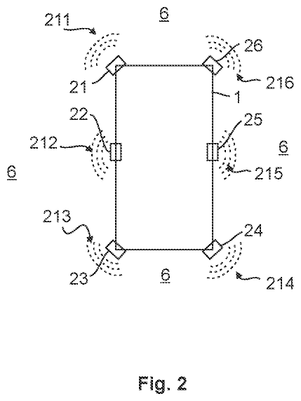

A radar system 2 of a vehicle 1 is illustrated schematically in FIG. 1, in which multiple radar sensors 21, 22, 23 are each provided with a processing device 3. Further radar sensors 24, 25, 26 of radar system 2 are schematically illustrated in FIG. 2. Processing devices 3 may each be used to carry out steps of a method according to the invention for operating radar system 2, which includes the at least two radar sensors 21, 22, 23, 24, 25, 26. For example, processing devices 3 are designed for this purpose as electronic data processing devices, which include at least one processor for carrying out the method steps. In addition, processing devices 3 may be data-linked to each other, in particular to exchange a result of an evaluation 104 with each other.

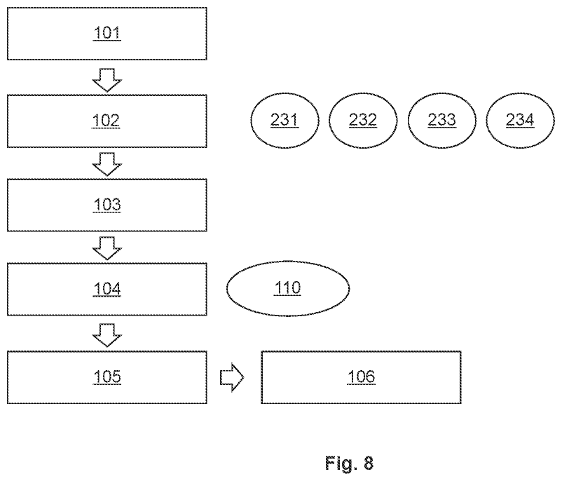

As illustrated in FIG. 8, the following steps may be carried out: Carrying out a signal transmission 101 in radar sensors 21, 22, 23, 24, 25, 26, for the purpose of transmitting at least one radar signal 211, 212, 213, 214, 215, 216 in each case (visualized in FIG. 2) into surroundings 6; Carrying out a signal processing 102 in radar sensors 21, 22, 23, 24, 25, 26 for the purpose of ascertaining a piece of detection information 231, 232, 233, 234 by radar sensors 21, 22, 23, 24, 25, 26 in each case, which is specific to radar signal 211, 212, 213, 214, 215, 216 transmitted in each case; Carrying out a disturbance evaluation 103 for the purpose of detecting at least one disturbance 251 in radar sensors 21, 22, 23, 24, 25, 26 in each case, based on the particular (for example four but advantageously also more) pieces of detection information 231, 232, 233, 234; Providing at least one adjustment option 110 for avoiding the at least one detected disturbance 251 by an adjustment 106 of signal transmission 101; Carrying out an evaluation 104 of the at least one adjustment option 110 for each of radar sensors 21, 22, 23, 24, 25, 26; Carrying out a coordination 105 of adjustment options 110 between the different radar sensors 21, 22, 23, 24, 25, 26, based on evaluation 104; and Carrying out adjustment 106 of signal transmission 101 according to the at least one adjustment option 110 depending on coordination 105.

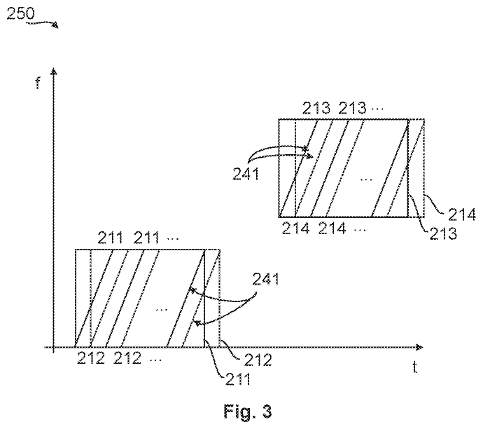

As shown in FIG. 3, radar sensors 21, 22, 23, 24, 25, 26 may be operated in a synchronized manner, for the purpose of transmitting the at least one radar signal 211, 212, 213, 214, 215, 216 in a synchronized manner in each case during signal transmission 101, so that radar signals 211, 212, 213, 214, 215, 216 of the different radar sensors 21, 22, 23, 24, 25, 26 are transmitted temporally offset and/or frequency-offset with respect to each other. A first radar signal 211, a second radar signal 212, a third radar signal 213 and a fourth radar signal 214, which are transmitted by different radar sensors 21, 22, 23, 24, 25, 26 during signal transmission 101, are illustrated as examples in frequency-time space 250 (i.e., frequency f of a radar signal 211, 212, 213, 214, 215, 216 over time t). To influence a mutual disturbance, radar signals 211, 212, 213, 214, 215, 216 of the different radar sensors 21, 22, 23, 24, 25, 26 are transmitted at least partially in parallel in time and offset in frequency-time space 250 in such a way that component signals 241 of radar signals 211, 212, 213, 214, 215, 216, in particular frequency-modulated ramps, are transmitted without overlapping with regard to frequency f. Component signals 241 are also shown with their frequency f, the solid line representing component signal 241 of first and third radar signals 211, 213, and the dashed line representing component signal 241 of second and fourth radar signals 212, 214. Moreover, the alternating transmission of component signals 241 of the different radar signals 211, 213 and 212, 214 is illustrated. The different radar signals 211, 213 and 212, 214 are thus transmitted temporally offset with respect to each other. Radar signal pairs 211, 212 and 213, 214 are furthermore transmitted frequency-offset with respect to each other. This ensures that none of component signals 241 overlap with respect to the frequency during signal transmission 101.

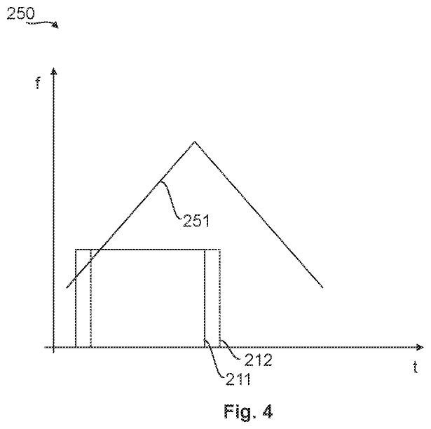

A disturbance 251 is illustrated in FIG. 4, which takes on a certain range in frequency-time space 250. The overlap with radar signals 211, 212 is clear. This makes it necessary to adjust radar signals 211, 212 in frequency-time space 250. For the sake of simplification, the discussion below only takes into account first two radar signals 211, 212.

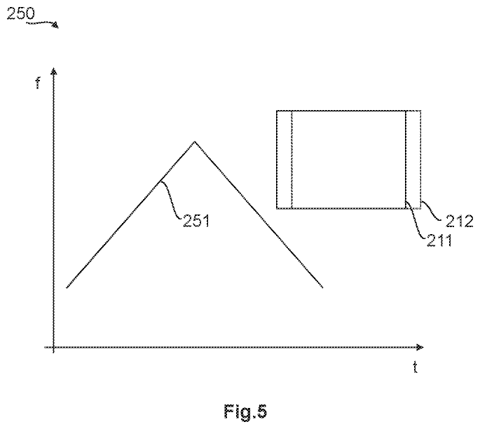

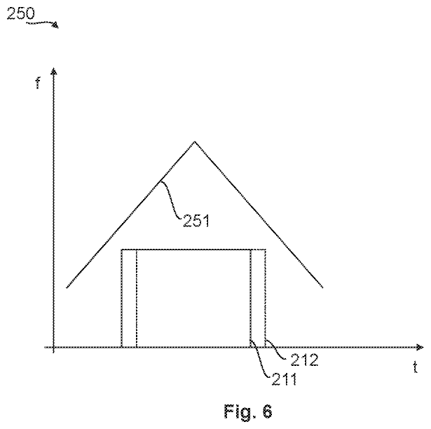

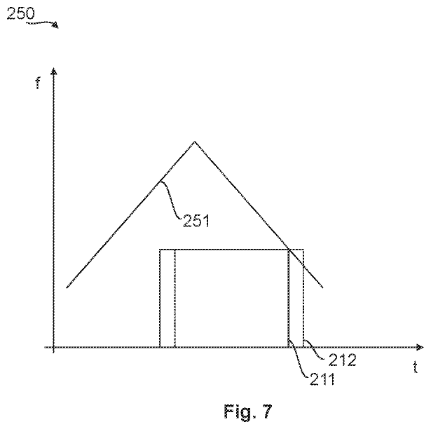

According to FIG. 5, adjustment 106 of signal transmission 101 may comprise, according to a first of the at least one adjustment options 110, an adjustment of a frequency range, in which radar signals 211, 212 are transmitted, in particular by a change of a center frequency of radar signals 211, 212. According to FIG. 6, adjustment 106 of signal transmission 101 may comprise, according to a second of the at least one adjustment options 110, an adjustment of a time delay, by which radar signals 211, 212 are transmitted, in particular by an adjustment of a starting time of radar signals 211, 212. A further second adjustment option 110 is shown in FIG. 7. This would be evaluated as being positive by first radar sensor 21 for first radar signal 211, while a disturbance would continue to result for second radar sensor 22 for second radar signal 212. Coordination 105 correspondingly results in that adjustment option 110 illustrated in FIG. 6, i.e., the corresponding delay, is preferred.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a radar system, which includes at least two radar sensors, the method comprising:
carrying out a signal transmission in the radar sensors to transmit at least one radar signal;
carrying out a signal processing in the radar sensors to ascertain a piece of detection information by the radar sensors that is specific to the radar signal transmitted in each case;
carrying out a disturbance evaluation to detect at least one disturbance in the radar sensors based on the particular piece of detection information;
providing at least one adjustment option to avoid the at least one detected disturbance by an adjustment of the signal transmission;
carrying out an evaluation of the at least one adjustment option for each of the radar sensors;
carrying out a coordination of the adjustment options between the different radar sensors based on the evaluation; and
carrying out the adjustment of the signal transmission according to the at least one adjustment option depending on the coordination.

2. The method according to claim 1, wherein the radar sensors are operated in a synchronized manner for the purpose of transmitting at least one radar signal in a synchronized manner during the signal transmission, so that the radar signals of the different radar sensors are transmitted temporally offset and/or frequency-offset with respect to each other.

3. The method according to claim 2, wherein the radar signals of the different radar sensors are transmitted at least partially in parallel in time and offset in a frequency-time space such that component signals of the radar signals or frequency-modulated ramps are transmitted without overlapping with regard to the frequency.

4. The method according to claim 1, wherein the adjustment of the signal transmission carries out at least one of the following adjustments:
according to one of the at least one adjustment options, an adjustment of a frequency range, in which the radar signals are transmitted, in particular by a change of a center frequency of the radar signals; or
according to a second of the at least one adjustment options, an adjustment of a time delay, by which the radar signals are transmitted, in particular, by an adjustment of a starting time of the radar signals.

5. The method according to claim 1, wherein the adjustment of the signal transmission is carried out identically for all radar sensors.

6. The method according to claim 1, wherein, by adapting the signal transmission, an adjustment of a time delay is carried out, at which the radar signals are transmitted to the same extent for all radar sensors to avoid a disturbance.

7. The method according to claim 1, wherein, by adjusting the signal transmission, an adjustment of a frequency range, in which the radar signals are transmitted, is changed to the same extent for all radar sensors.

8. The method according to claim 1, wherein a result of the disturbance evaluation is used as a prediction of a disturbance of the pieces of detection information.

9. The method according to claim 1, wherein the at least one disturbance is detected in the radar sensors in each case, based on the particular piece of detection information such that the disturbance evaluation comprises an application of a neural network in each case for the purpose of predicting the disturbance such that an indication of a disturbance frequency range takes place, due to the neural network, in which the disturbance will be present in the future.

10. The method according to claim 1, wherein the disturbance evaluation takes place based on the pieces of detection information of a current detection cycle of the radar systems for the purpose of obtaining an indication of a disturbance frequency range as a result of the disturbance evaluation, in which the disturbance is predicted in a detection cycle temporally subsequent to the current detection cycle, the adjustment of the signal transmission comprising an automatic, at least partial adjustment of the frequency range of the radar signals so that the radar signals are transmitted in a frequency range which is at least partially outside the predicted disturbance frequency range.

11. The method according to claim 1, wherein the disturbance evaluation is carried out separately and, in particular autonomously, in each case for the pieces of detection information from different radar sensors and a result of the evaluation of each of the radar sensors is used in the coordination.

12. The method according to claim 1, wherein the carrying out of the evaluation of the at least one adjustment option for each of the radar sensors comprises: evaluating an effect of each adjustment option in the form of a disturbance effect on the radar sensor based on at least one current and/or predicted disturbance detected by the disturbance evaluation, a result of the evaluation being transferred to the other radar sensors.

13. The method according to claim 1, wherein the radar system is part of a vehicle.

14. The method according to claim 1, wherein the radar sensors each include a processing device for carrying out at least the evaluation, and wherein the radar system is designed to detect at least one target object in surroundings of the radar system, in particular of a vehicle, and wherein the radar system includes the at least two radar sensors for different surroundings regions of the surroundings.

15. The method according to claim 1, wherein the radar system includes at least four radar sensors or at least six radar sensors.
